(19) United States
(12) Patent Application Publication
(10) Pub. No.: US 2023/0252475 A1
(43) Pub. Date: Aug. 10, 2023

(54) System With A Motor Vehicle And A Data Server Device External To The Motor Vehicle, Motor Vehicle With A User Recognition Device, Method For Operating A Motor Vehicle, Control Device And Server Device

(71) Applicant: AUDI AG, Ingolstadt (DE)

(72) Inventors: Hendrik GRONAU, Ingolstadt (DE); Jörg MICHAEL, Ingolstadt (DE); Christoph SCHMUTZ, Demling (DE); Thorsten SCHRADER, Ingolstadt (DE); Werner WILDING, Gungolding (DE)

(73) Assignee: AUDI AG, Ingolstadt (DE)

(21) Appl. No.: 18/166,816

(22) Filed: Feb. 9, 2023

(30) Foreign Application Priority Data
Feb. 9, 2022 (DE) 10 2022 102 984.0

(51) Int. Cl. G06Q 20/40; G06Q 20/32

(52) U.S. Cl. CPC G06Q 20/40145; G06Q 20/3274; G06Q 20/3278; G06Q 2240/00

(57) ABSTRACT

The disclosure relates to a motor vehicle having a user recognition device, a user interface, a communication interface for wirelessly providing information to the external environment of the motor vehicle, and a control device. The control device is configured: to register the user on the basis of his determined identity; to select a payment function on the basis of the operating signal; to provide the order data signal during the use of the motor vehicle by the registered user, which signal describes an order data set that describes the registered user’s payment process information that is coupled to the selected payment function and is stored in the user profile; and to transmit the provided order data signal to the communication interface for communicating the payment process information to an extravehicular communication interface of an extravehicular data server device.

### TECHNICAL FIELD

The present disclosure relates to a system comprising a motor vehicle and an extravehicular data server device. The present disclosure also relates to the motor vehicle, which comprises a user recognition device, and a user interface for receiving and detecting an operating action of the user, a communication interface, and a control device. The system according to the present disclosure can also be referred to as a dialog system with booking, planning and payment functions.

### BACKGROUND

In current motor vehicles, there are already functions that allow the user to enter, for example, destinations into the navigation system by voice command or to search for and call persons from the phone book. In addition, there are user programs (“apps”) from motor vehicle manufacturers that allow the user to remain connected to the motor vehicle via his terminal. Here, inter alia, current fuel and/or charge levels can be read, navigation data can be transmitted or air-conditioning preferences can be preset. Through the websites of some motor vehicle manufacturers, what are known as “functions on demand” (“FoDs”), that is to say on-demand functions, such as, for example, an interface between the smartphone and the motor vehicle, can already be booked for the user’s own motor vehicle.

A disadvantage is that the current functionalities in each case fall short, i.e., do not have a very wide range, and are not connected to one another. For example, on-line shopping, motor-vehicle-related software updates and other services each have their own apps, and customer account data must be present in each app. For each process, a credit card number or a password must also be entered, which is undesirable during travel.

EP 3 363 706 A1 discloses a method and a system for activating at least one motor vehicle function, wherein proposed functions can be recognized for certain situations and suggestions can be managed, and a function can be activated in real time.

US 2018/0201226 A1 describes a method and system for authenticating a user of a motor vehicle.

With “Trive.me” an individual “car account” is known, comparable to a user profile for mobile terminals (https://www.all-electronics.de/automotive-transportation/function-on-demand.html).

However, the solutions from the prior art have the disadvantage that during travel the application can be run only by a passenger who has to, for example, input a password to perform the individual purchasing process, for example, to purchase a function-on-demand, i.e., a software update for the motor vehicle. The driver is therefore dependent on external help and may need to give the passenger his password or his PIN.

### BRIEF DESCRIPTION OF DRAWINGS

The accompanying drawings, which are incorporated herein and form a part of the specification, illustrate the embodiments of the present disclosure, and together with the description, further serve to explain the principles of the embodiments and enable a person skilled in the pertinent art to make and use the embodiments, individually, or as a combination thereof.

FIG. 1 is a schematic representation of a first exemplary embodiment of the method, according to some embodiments.

FIG. 2 is a schematic representation of another exemplary embodiment of the method, according to some embodiments.

FIG. 3 is a schematic representation of an exemplary embodiment of the server device, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

An object of the present disclosure is to enable the driver to use a customer account in the motor vehicle securely.

The stated object is achieved by the devices according to the present disclosure, by the system according to an embodiment and by the method according to an embodiment in accordance with the independent claims. Advantageous developments are provided by the dependent claims.

The idea is based on the principle of creating a kind of “marketplace” in the motor vehicle that represents the single interface in the motor vehicle of the user of the motor vehicle and his virtual environment. In other words, a portal in the motor vehicle is provided, with which not only motor-vehicle-bound functions can be purchased, but additionally also services or functions that are not bound to the motor vehicle. The identity of the user, in particular the driver, is determined by a user recognition device of the motor vehicle, that is to say by a motor vehicle sensor system, and the motor vehicle thus becomes the “proof of verification.” As a result, an on-line purchase or on-line booking, for example, can be effected via a communication interface of the motor vehicle without the identified user having to re-enter, for example, a password or a credit card number every time. In other words, it is made possible for a payment function to be approved only on the basis of the initially detected identity of the user, in that user-specific payment process information is saved in a user profile of the user, which is stored in the motor vehicle, and is approved by the initial check of the identity. Such payment process information can, for example, be information about an account of the identified user or a credit card.

In other words, the motor vehicle handles the identification of the user and thus the approval of the personal data for a payment process, and the motor vehicle handles payment in that it transmits the relevant data for everything in the payment process via its communication interface to the data server external to the motor vehicle. If a user is then identified in the motor vehicle for whom no user profile is present, this user will not be able to use the payment process information of another user for whom there is a corresponding user profile.

As a result, an interface to the payment functions and devices is provided and made available for the user of the motor vehicle. The motor vehicle takes over the function of the “password,” meaning it replaces a password input for individual transactions. While the identified user is driving, the passenger will also be able to pay for something from the customer account of the driver, but only if the driver is present. A payment process can also be performed during travel, since the motor vehicle handles the purchase processing, i.e., the payment function. This results in a high level of security during on-line purchases, as well as significantly increased traffic safety. A very large number of functionalities can be linked to one another, resulting in a great benefit for the user of the motor vehicle.

The motor vehicle according to an embodiment is preferably designed as an automobile, in particular as a passenger car or a truck, or as a passenger bus or a motorcycle. The motor vehicle according to an embodiment comprises a user recognition device for determining the identity of a current user of the motor vehicle. A user recognition device is thus a device, a device component or a device group which is designed to determine the identity of a user. For this purpose, the user recognition device also comprises one or more components, preferably a sensor system, for detecting the identity, in other words, for example, a sensor system for detecting a biometric feature such as, for example, a fingerprint or a face, and/or a sensor for receiving and reading a signal from a motor vehicle key.

The user recognition device can be, for example, a component of a control device and accordingly be designed as a control chip or circuit board of the control device, or a component which is installed externally to the control device. For the optional detection of the user, the user recognition device can have, for example, a sensor for detecting a motor vehicle key of the user, or, for example, a camera and an algorithm for facial recognition of the user.

The motor vehicle further comprises a user interface, which is configured to receive and detect an operating action of the user for activating a payment function, that is to say for activating a fee-based function for booking and/or purchasing a service and/or a purchase object. For this purpose, the user interface can have, for example, a button or a turn/push actuator for detecting an operating action executed by means of the button and/or the turn/push actuator; a microphone for receiving a voice command; a camera for detecting a contactless operating gesture; and/or a touch-sensitive screen and/or a touch pad. The user interface is also configured to generate an operating signal which describes the detected operating action.

The motor vehicle further comprises a communication interface for wirelessly providing information to an external environment of the motor vehicle. In other words, the communication interface is designed to communicate to the external environment of the motor vehicle information described by an intravehicular signal. This means that the communication interface can present the information, for example, to the external environment, for example by a voice output or on a display of a screen of the communication interface. Alternatively or additionally, the information can be communicated to the external environment by a data transfer, for example by near-field communication or by means of an infrared interface of the communication interface. In other words, the communication interface is designed for wireless data transmission and/or presentation of the information.

The motor vehicle also comprises the control device. This can optionally comprise, for example, the user recognition device and/or the user interface.

A control device is understood to mean a device, a device component or a device group which is configured to receive and evaluate signals, as well as to generate control signals. For this purpose, the control device can ideally have a receiving module and a transmission module, and preferably a processor device. The control device can be designed, for example, as a control unit or control chip, or as a computer program or computer program product.

The control device of the motor vehicle according to an embodiment is configured to register the user for the current use of the motor vehicle – i.e., for the current utilization process of the motor vehicle, for example for the current journey until he gets back out of the motor vehicle – on the basis of the determined identity. Registration will take place if a user-specific user profile for the detected user is stored in the motor vehicle. This user profile can be stored, for example, in a data memory of the control device or recognized on the basis of a motor vehicle key of the user and/or downloaded from the motor vehicle key. Optionally, registration can take place on the basis of a user recognition signal of the user recognition device, which describes the determined identity of the current user.

The control device is further configured to select, on the basis of the operating signal, a payment function from a plurality of payment functions which are stored for the registered user in the user profile. In other words, the control device selects a payment function for which the user is authorized. For this purpose, the user profile can describe for example customer data and/or for example a password or a PIN for each of the payment functions. This step involves coupling the payment function to be activated to the user profile, i.e., coupling to the personal assistant.

Furthermore, the control device is configured to provide an order data signal during the use of the motor vehicle by the registered user, which order data signal describes an order data set that describes the registered user’s payment process information that is coupled to the selected payment function and stored in the user profile. The payment process information therefore describes data for payment of a service or the like of the selected payment function. In other words, the payment process information may describe payment function data for payment of a service or booking.

The control device is configured to transmit the provided order data signal to the communication interface for communicating the payment process information to a communication interface external to the motor vehicle of an extravehicular data server device.

A data server device is understood to mean a device, a device component or a device group that is configured for data processing. The data server device can be, for example, a data cloud, or a server, and can therefore also be referred to as a data processing device or server device. The control device can thus transmit the payment process information to, for example, a data server device of a parking garage by means of the motor vehicle’s own communication interface if the motor vehicle is, for example, at a barrier of the parking garage in the vicinity of the communication interface of the extravehicular data server device. If the intravehicular communication interface is designed to present information, it can present this to a scanner of the parking garage, for example via a screen, a quick response (QR) code that encodes the account data of the registered user.

This results in the advantages explained above.

In a preferred embodiment of the motor vehicle according to the present disclosure, the intravehicular communication interface can be designed as a display device with a display surface. A display device is understood to mean a device, a device component or a device group which is configured to display image content on the display surface. The display device can be designed, for example, as a screen or device with a screen.

The display surface is oriented towards the external environment of the motor vehicle and is visible from outside the motor vehicle. The display device can be arranged, for example, in the interior of the motor vehicle, wherein the display surface is oriented towards a window pane of the motor vehicle, so that the display surface is visible from the outside. However, the display surface can preferably be on an outside of the motor vehicle, wherein the screen can be embedded, for example, in the outer skin of the motor vehicle.

In this embodiment, the control device can be configured to provide the order data set as an image data set and to cause the intravehicular communication interface to output the image data set. The information of the order data set can, for example, be shown as text information, but preferably as a QR code. Accordingly, the control device can be configured to provide the provided order data set as a QR code. In the case of a QR code, the result is that advantageously the user’s account data, for example, can now be read with a high degree of data security by a corresponding reader.

In a further preferred embodiment of the motor vehicle according to the present disclosure, the intravehicular communication interface can be designed as an infrared interface for wireless data transmission. This embodiment of the intravehicular communication interface can also preferably be arranged on an outside of the motor vehicle. As a result, data security is still very much higher than when image information, for example a QR code, is displayed.

Optionally, the intravehicular communication interface of the motor vehicle can be designed as a combination of an infrared interface and a display device. This provides greater variability when transmitting the data.

In order to enable a further security level for monitoring the authorization for performing the payment process, in a particularly preferred embodiment of the motor vehicle according to the present disclosure, the control device can be configured to cause the user recognition device to determine the identity of at least one occupant of the motor vehicle - preferably all occupants of the motor vehicle - before every transmission of an order data signal, for example before each generation of the order data signal. The control device is then additionally configured to transmit or provide the payment data set only if the registered user with the determined identity is still in the motor vehicle.

In other words, the control device according to this embodiment can be configured to check before each generation of an order data signal whether the registered user is still in the motor vehicle, and to provide the payment data set only if the registered user with the determined identity is still in the motor vehicle.

Ideally, this check can take place immediately before the transmission of the order data set. Ideally, the user recognition device can be designed for facial acquisition and/or facial recognition. With this type of verification of identity, the user, even if he is the driver, does not have to deal with, for example, entering a password or with one hand providing a fingerprint. In other words, this further identification is tied to a single transaction, while the identification for registration of the user is not tied to individual transactions. A further safety level is thereby included. This significantly increases not only data security but also safety in road traffic.

The user recognition device can preferably determine the identity of the user on the basis of a user’s mobile terminal which is coupled to the motor vehicle, for example by checking a serial number of the mobile terminal. Additionally or alternatively, the user recognition device can be designed for facial recognition. These checking measures make it possible for the user, even when he is the driver, not to have to deflect his attention to, for example, inputting a password or providing a fingerprint. Accordingly, traffic safety is significantly increased, as is ease of operation.

The object stated above is achieved by a system which comprises an embodiment of the motor vehicle according to the present disclosure, as well as an extravehicular data server device. Preferably, the extravehicular data server device can be a data server device of a parking garage, a charging station, a fuel pump and/or a toll station.

This results in the aforementioned advantages.

The object stated above is achieved by a method for operating an embodiment of the motor vehicle according to the present disclosure.

To execute the method, the control device of the motor vehicle checks on the basis of a determined identity of a user of the motor vehicle whether a user profile for the user determined is present in the motor vehicle. The control device registers the user as the current user of the motor vehicle during the current utilization process of the motor vehicle if the user profile is present. On the basis of an operating signal from the user interface of the motor vehicle, which describes an operating action of the user for activating a payment function, the control device selects a payment function from a plurality of payment functions for which an authorization is stored for the registered user in the user profile of the motor vehicle. During use of the motor vehicle by the registered user, the control device provides an order data signal, which describes an order data set that describes the registered user’s payment process data that is coupled to the selected payment function and stored in the user profile. The control device transmits the provided order data signal to a communication interface of the motor vehicle for communicating the payment process information to the communication site external to the motor vehicle of an extravehicular data server device.

This results in the advantages discussed above.

Preferably, the control device can execute one or more method steps which have already been mentioned above in connection with the further embodiments of the motor vehicle according to the present disclosure.

The present disclosure also relates to the control device. The control device can have a data processing device or a processor device which is configured to perform an embodiment of the method according to the present disclosure. For this purpose, the processor device can have at least one microprocessor, and/or at least one microcontroller, and/or at least one FPGA (field programmable gate array), and/or at least one DSP (digital signal processor). Furthermore, the processor device may comprise program code which, when executed by the processor device, is configured to execute the embodiment of the method according to the present disclosure. The program code can be stored in a data storage device of the processor unit. The control device can preferably be configured as a control apparatus, control chip, control unit or user program (“app”).

The object stated above is achieved by a storage medium having a program code which is configured, when executed by a processor device, preferably a processor device of a mobile terminal, to cause the control device to execute an embodiment of the method described above. The storage medium can be designed, for example, as a memory card or memory chip or other data store. Processor device is understood to mean a device or a device component for electronic data processing. The processor device can comprise, for example, at least one microcontroller and/or at least one microprocessor. This results in the aforementioned advantages.

The object stated above is achieved by a server device for operating on the internet, for example a data server, a back-end and/or a data cloud, wherein the server device comprises an embodiment of the storage medium according to the present disclosure and/or with an embodiment of the control device according to the present disclosure.

The present disclosure also includes developments of the system according to an embodiment, the method according to an embodiment, the control device according to an embodiment, and the server device according to an embodiment, which developments have features as already described in connection with the developments of the motor vehicle according to an embodiment. For this reason, the corresponding developments of the system according to an embodiment, the method according to an embodiment, the control device according to an embodiment and the server device according to an embodiment are not described again here.

The present disclosure also comprises the combinations of the features of the described embodiments. The present disclosure therefore also comprises implementations which each have a combination of the features of a plurality of the described embodiments, provided the embodiments have not been described as mutually exclusive.

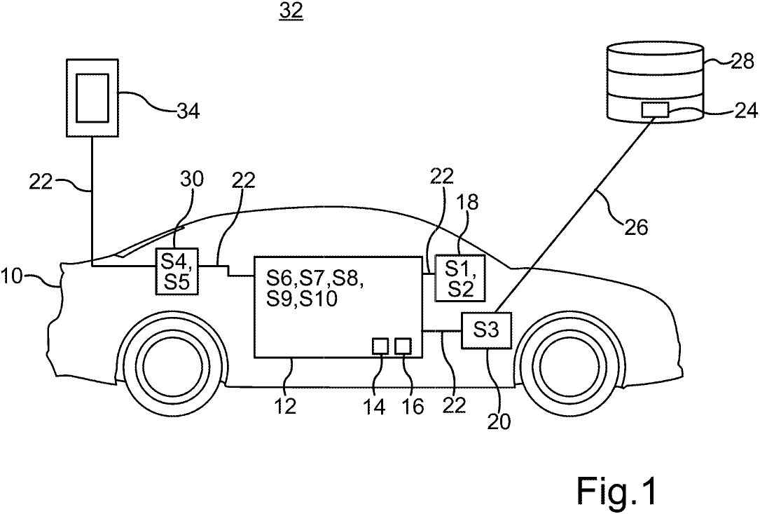

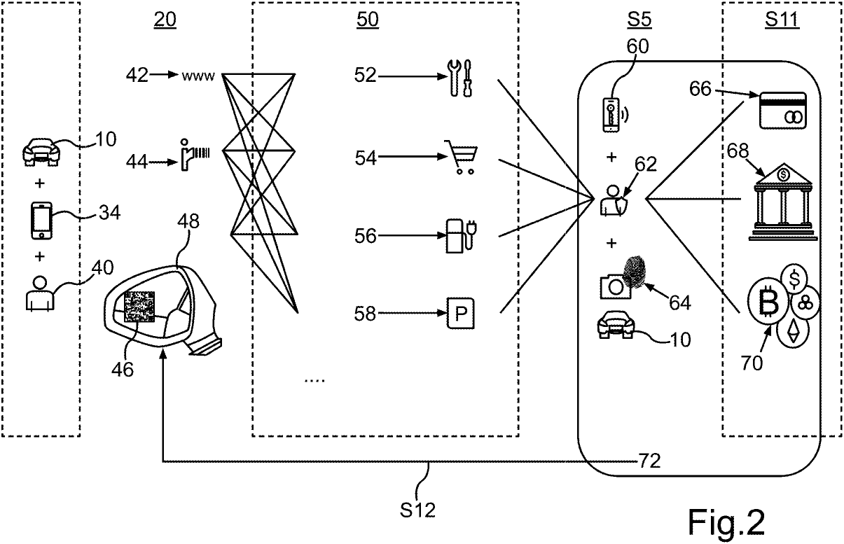

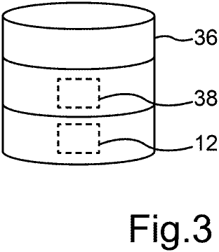

In the following, exemplary embodiments of the present disclosure are described. Shown are:
FIG. 1 a schematic representation of a first exemplary embodiment of the method according to the present disclosure and of the device according to the present disclosure;
FIG. 2 a schematic representation of another exemplary embodiment of the method according to the present disclosure; and
FIG. 3 a schematic representation of an exemplary embodiment of the server device according to the present disclosure.

The exemplary embodiments described below are preferred embodiments of the present disclosure. In the exemplary embodiments, the described components of the embodiments each represent individual features of the embodiments that are to be considered independently of one another, each also further developing the embodiments independently of one another. For this reason, the present disclosure is also intended to include other combinations of the features of the embodiments than those described. Additionally, the described embodiments can also be complemented by additional, already described features of the present disclosure.

In the figures, the same reference signs refer to functionally identical elements.

FIG. 1 illustrates a first exemplary embodiment in which a motor vehicle 10, for example a passenger car, has a control device 12. The control device 12 can preferably have a processor device 14 and/or a data memory 16.

The control device 12 communicates with the user interface 18 and the communication interface 20 via data communication connections 22. These can either be wired or wireless. Accordingly, the data communication connections 22 can be designed as a data bus, a Bluetooth connection or a WiFi connection.

Via a preferably wireless data communication connection 26, the control device 12 can also communicate with a communication interface 24 of an extravehicular data server device 28 and/or present data as image information.

The user interface 18 is configured to detect and recognize (S1), for example, via a touch-sensitive screen or by detecting a contactless operator gesture, an operating request of a user for activating a payment function. An operating signal (S2) generated accordingly by the user interface 18 then describes the captured operating action.

The intravehicular communication interface 20 can ideally be or comprise an infrared interface which is arranged on an outer side of the motor vehicle 10, for example is embedded in the outer skin. Alternatively or additionally, the intravehicular communication interface 20 can comprise, for example, a screen whose display surface is oriented towards the outside. The data communication S3 between the intravehicular communication interface 20 and a communication interface 24 external to the motor vehicle can transmit data to the extravehicular communication interface 24 via infrared light not visible to the human eye (as illustrated in FIG. 1 by the data communication connection 26), for example account data. If the intravehicular communication interface 20 is designed as a screen, the presentation of the exemplary account data takes place optically, for example via a displayed QR code. This is advantageous if the extravehicular communication interface 24 is designed as a QR scanner. In the example in FIG. 1, the extravehicular communication interface 24 is shown schematically as part of an extravehicular data server device 28. This can be, for example, a data server, a data cloud or a device in, for example, a parking barrier installation.

The motor vehicle 10, which can be designed, for example, as a passenger car, also comprises a user recognition device 30, which can be designed, for example, for facial recognition as part of a detection of the current user of the motor vehicle (S4) and the determination of their identity (S5). Alternatively or additionally, the user recognition device 30 can also have a fingerprint sensor and/or a sensor system for receiving an identification signal from a motor vehicle key, preferably in the context of a Keyless-Go system.

In the example in FIG. 1, the corresponding system 32 for performing the payment function is then composed of the motor vehicle 10 and the extravehicular data processor 28.

In the example in FIG. 1, a user can, with the aid of the control device 12, have already registered (S6) as a user, for example, for the current journey to a parking garage. For the registration S6, it can ideally be provided that the control device 12 checks (S7) whether a user-specific user profile for the user identified is stored in the motor vehicle 10 (and/or in the motor vehicle key).

When approaching, for example, a parking barrier, the user can select a parking ticket for the parking garage as a payment function via, for example, a touch-sensitive screen of an instrument cluster of the motor vehicle 10. On the basis of the corresponding operating signal, the control device 12 selects, by way of example, the purchase of a parking ticket as the payment function in S8. By means of the user profile of the identified user, a plurality of payment functions can be enabled for the user, for example, purchasing a parking ticket in this parking garage or in a parking garage with a corresponding payment system, paying for charging processes at a charging station and/or refueling at fuel pumps, an access to social media, booking a restaurant, functions of the “internet of things,” for example, opening and/or closing a garage, and mobility services such as, for example, booking what are known as “functions on demand,” i.e., software updates for a driver assistance system of the motor vehicle 10 and/or for motor vehicle systems of the motor vehicle 10. The control device 12 thus provides a portal for the purchase and booking of different services. In another example, the user can drive to a workshop with the motor vehicle 10, which has, for example, an unserviceable tire, and would like to book and pay for the repair as the payment function.

Another exemplary mobility service can be a purchase of a ticket for a public transportation means in which the motor vehicle 10 can book and/or pay, for example, for a ticket for a shuttle system between a park-and-ride parking garage and a city center. In this example, a mobile terminal 34 of the user 40 can preferably be coupled to the motor vehicle 10, and the control device 12 can, for example, transmit a bus ticket to the mobile terminal 33 after the purchase.

The control device 12 provides the order data signal (S9) which, in the example in FIG. 1, can describe the desired ticket as well as the user’s account data. In other words, the order data signal describes an order data set with the account data and, for example, the type of ticket. In S10, the control device 12 transmits the provided order data signal to the intravehicular communication interface 20, and the exemplary intravehicular communication interface 20 transmits the data via infrared light to the extravehicular communication interface 24. The account data are transmitted to the data server device 28 of the parking garage, and the motor vehicle 10 can enter.

If the method comprises an additional security level, then the user recognition device 30 will once again determine the identity of the user, ideally immediately before the generation S9 of the order data signal or before the transmission S10 thereof (S5) and will cause the order data signal S9 and/or the transmission S10 thereof to be provided only if the user identified at the beginning is still in the motor vehicle.

In FIG. 1, the option is also shown of the user recognition device 30 determining the identity of the user via a mobile terminal 34 of the user (S5), for example on the basis of checking a serial number of the mobile phone or via identification data transmitted by the mobile terminal 34. The communication between the mobile terminal 34 and the user recognition device 30 can take place, for example, via a WiFi connection, a Bluetooth LE connection, or via a mobile data connection.

FIG. 2 illustrates a further exemplary embodiment, wherein in FIG. 2 the relationships of the individual components are shown as a “marketplace.” On the user’s side, the motor vehicle 10, preferably also the user’s mobile terminal 34, as well as the user 40 himself are available for performing payment functions. The intravehicular communication interface 20 can communicate the order data signal of the control device 12, for example, via an internet connection 42 (“www”), via an infrared data connection 44 and/or via ideally a QR code 46, which can be displayed, for example, in a side mirror 48, wherein the order data signal can describe a service 50.

In other words, the exterior mirror 48 can comprise the intravehicular communication interface 20, which can be designed as a screen with a display surface.

FIG. 2 indicates the different possible combinations of data transmission and services 50.

Exemplary services are, for example, a repair 52, on-line shopping 54, a charging process 56 at a charging station and/or parking 58 in the parking garage.

The determination of the identity S5 of the user 40, i.e., for example, an authentication, can be effected, for example, via a vehicle key 60, for example in the context of a Keyless-Go system, and/or facial recognition 62 and/or via a fingerprint 64.

The payment S11 can take place, for example, via a credit card payment 66, transfer 68 from a bank account and/or through a transfer 70 of a virtual currency.

FIG. 2 illustrates a “marketplace” 72 that can communicate with the user 40 and service partners (S12).

FIG. 3 shows an exemplary server device 36, which can be designed, for example, as a data server, and which can comprise an embodiment of the control device 12, and/or a storage medium 38, for example a hard drive or a memory chip. If the data server comprises a storage medium 38, this can have a program code for executing the method.

Overall, the examples show how a dialog system with a booking, planning and/or payment function can be provided.

A kind of “marketplace” can be created by the motor vehicle 10 and the method. This “marketplace” then represents the single interface of a user to his virtual environment. Only a one-time registration and verification in the motor vehicle 10 or on the mobile terminal 34 (“device”) for the marketplace is required and then all services can be used/registered via the marketplace, even those of third-party providers:
Booking, payment and authentication of functions-on-demand (FoDs)
Reservation, payment and communication with charging stations
Authentication and payment function for on-line shops
Authentication and access to information sources and social media
Reservation, authentication and data exchange, for example with restaurants
Authentication and communication, for example, with a garage (automatic door opening)
Reservation, payment, authentication and communication, for example, with a parking garage and public parking lots (the motor vehicle 10 pays incurred parking fees automatically)
Reservation, payment, authentication and communication with other mobility service providers for entry into cities or into areas and regions without car traffic.

An interface to all services, functions and devices is advantageously provided for the user.

In a preferred technical implementation, the motor vehicle 10 can partially slip into the role of a payment service provider (PSP). In this case, the focus is on services from inside the motor vehicle 10. The focus is explained by the motor vehicle 10 itself serving as a verification device.

The motor vehicle 10 executes a registration (S6). A credit card, an account or a wallet address is stored by the user. The motor vehicle 10, device and “account data” are then connected via the marketplace. If the user is sitting with his device in the motor vehicle 10 and they are connected, a verification will thus be provided. At, for example, irregular intervals, the motor vehicle 10 can additionally perform facial comparison via the interior cameras and authenticate the user (S5).

If the user uses different services via the internet access of the motor vehicle 10, for example charging at charging stations, parking in parking garages or purchasing FoDs, the communication between the motor vehicle 10 and the service provider will take place, for example, via infrared interfaces. The motor vehicle 10 automatically logs in the motor vehicle 10/driver without intervention by the driver. Payment handling always takes place independently of providers and payment methods, since the user and motor vehicle 10 are already known via the marketplace and the market place handles the payment process. Depending on the user’s preference(/trust), this can take place automatically, after confirmation or only after the transaction data have been viewed by the user.

The automatic authentication S5 of the user by preferably unlocking the motor vehicle 10 and optionally additionally connecting to his device as well as the comparison of facial recognition make the user transparent and trustworthy for the service providers. Functions-on-demand (“FoDs”) can be purchased and installed in real time and the motor vehicle 10 can be charged, repaired or parked immediately even without cash, since authentication S5 and payment S10 are preferably automatically handled via an infrared interface and/or a QR code generated by the motor vehicle 10. For example for example, a small simple black-and-white screen in the exterior mirror is suitable for the QR code. This can be scanned in payment booths, charging stations, toll stations, ferries and/or parking garages and used to approve the payment.

Services such as the reservation of parking spaces, charging stations or restaurant bookings can take place on-line. Here too, the user is known and his user data is managed by the marketplace. This function can ideally be coupled closely with the personal assistant in the motor vehicle 10. This coupling enables a “barrier-free” management of calendar entries, user requests and services without long and redundant authentication and confirmation.

1-10. (canceled)

11. A motor vehicle comprising:
a user recognition device configured to determine an identity of a user of the motor vehicle;
a user interface, wherein the user interface detects an operating action of the user for activating a payment function and generates an operating signal comprising the detected operating action;
an intravehicular communication interface for wirelessly providing information to an external environment of the motor vehicle; and
a control device configured to:
register, as a registered user, the user for a current use of the motor vehicle on the basis of the determined identity, provided a user-specific user profile for the user is stored in the motor vehicle;
select, based on the operating signal, a payment function from a plurality of payment functions that are stored in the user profile for the registered user;
provide, during the use of the motor vehicle by the registered user, an order data signal comprising an order data set that includes payment process information of the registered user, the payment process information being coupled to the selected payment function and being stored in the user profile; and
transmit the provided order data signal to the intravehicular communication interface for communicating the payment process information to an external communication interface of an extravehicular data server device, the extravehicular data server device being outside of the vehicle.

12. The motor vehicle according to claim 11, wherein the intravehicular communication interface is configured as a display device with a display surface, wherein the display surface is oriented towards the external environment of the motor vehicle and is visible from outside the motor vehicle, and wherein the control device causes the intravehicular communication interface to output the order data set provided as an image data set, and wherein the control device provides the provided order data set as a quick response (QR) code.

13. The motor vehicle according to claim 11, wherein the intravehicular communication interface is configured as an infrared interface for wireless data transmission arranged on an outside of the motor vehicle.

14. The motor vehicle according to claim 11, wherein the control device is configured to:
cause the user recognition device to determine the identity of at least one occupant of the motor vehicle before each generation of an order data signal; and
transmit the payment data set only if the registered user with the determined identity is still in the motor vehicle.

15. The motor vehicle according to claim 11, wherein the user recognition device is configured to determine the identity of the user on the basis of a mobile terminal of the user coupled to the motor vehicle or the user recognition device is configured for facial recognition.

16. A system comprising:
a motor vehicle comprising:
a user recognition device configured to determine an identity of a user of the motor vehicle;
an intravehicular user interface, wherein the user interface detects an operating action of the user for activating a payment function and generates an operating signal comprising the detected operating action;
a communication interface for wirelessly providing information to an external environment of the motor vehicle; and
a control device configured to:
register, as a registered user, the user for a current use of the motor vehicle on the basis of the determined identity, provided a user-specific user profile for the user is stored in the motor vehicle;
select, based on the operating signal, a payment function from a plurality of payment functions that are stored in the user profile for the registered user;
provide, during the use of the motor vehicle by the registered user, an order data signal comprising an order data set that includes the payment process information of the registered user, the payment process information being coupled to the selected payment function and being stored in the user profile; and
transmit the provided order data signal to the intravehicular communication interface for communicating the payment process information to an external communication interface; and
an extravehicular data server device comprising the external communication interface, wherein the extravehicular data server device is outside the vehicle.

17. The system according to claim 16, wherein the extravehicular data server device is a data server device of a parking garage, a charging station, a fuel pump, or a toll station.

18. A method for operating a motor vehicle comprising a control device, wherein the control device of the motor vehicle is configured to perform the method comprising:
checking, based on a determined identity of a user of the motor vehicle, whether a user profile is present in the motor vehicle for the user;
registering the user as a current user of the motor vehicle during use of the motor vehicle if the user profile is present;
selecting, on the basis of an operating signal from a user interface of the motor vehicle that describes an operating action of the user for activating a payment function, a payment function from a plurality of payment functions, wherein an authorization is stored for the registered user in the user profile of the motor vehicle;
providing, during the use of the motor vehicle by the registered user, an order data signal comprising an order data set that includes the payment process data of the registered user, the payment process data being coupled to the selected payment function and stored in the user profile; and
transmitting the provided order data signal to an intravehicular communication interface of the motor vehicle for communicating the payment process information to an extravehicular communication interface of an extravehicular data server device.

19. A control device located within a motor vehicle, the control device being configured to:
check, based on a determined identity of a user of the motor vehicle, whether a user profile is present in the motor vehicle for the user;
if the user profile is present, register the user as a current user of the motor vehicle during use of the motor vehicle;
select, on the basis of an operating signal from a user interface of the motor vehicle that describes an operating action of the user for activating a payment function, a payment function from a plurality of payment functions, wherein an authorization is stored for the registered user in the user profile of the motor vehicle;
provide, during the use of the motor vehicle by the registered user, an order data signal comprising an order data set that includes payment process data of the registered user, the payment process data being coupled to the selected payment function and stored in the user profile; and
transmit the provided order data signal to an intravehicular communication interface of the motor vehicle for communicating the payment process information to an extravehicular communication interface of an extravehicular data server device.

20. A server device for operating on the internet, the server device comprising a control device configured to:
check, based on a determined identity of a user of a motor vehicle, whether a user profile is present in the motor vehicle for the user,
if the user profile is present, register the user as a current user of the motor vehicle during use of the motor vehicle;
select, on the basis of an operating signal from a user interface of the motor vehicle that describes an operating action of the user for activating a payment function, a payment function from a plurality of payment functions where an authorization is stored for the registered user in the user profile of the motor vehicle;
provide, during the use of the motor vehicle by the registered user, an order data signal comprising an order data set that includes payment process data of the registered user, the payment process data being coupled to the selected payment function and stored in the user profile; and
transmit the provided order data signal to an intravehicular communication interface of the motor vehicle for communicating the payment process information to an extravehicular communication interface of an extravehicular data server device.
